(19) United States
(12) Patent Application Publication
(10) Pub. No.: US 2013/0011687 A1
(43) Pub. Date: Jan. 10, 2013

(54) MULTILAYER POLYMIDE FILM AND FLEXIBLE METAL LAMINATED BOARD

(75) Inventors: Teruo Matsutani, Osaka (JP); Yasutaka Kondo, Osaka (JP); Shogo Fujimoto, Osaka (JP); Shinji Matsukubo, Osaka (JP); Hisayasu Kaneshiro, Osaka (JP)

(73) Assignee: KANEKA CORPORATION, Osaka-shi, Osaka (JP)

(21) Appl. No.: 13/522,546

(22) PCT Filed: Jan. 13, 2011
(86) PCT No.: PCT/JP2011/050420

§ 371 Date: Aug. 30, 2012

(30) Foreign Application Priority Data
Jan. 18, 2010 (JP) 2010-008294

(51) Int. Cl. B32B 15/08; B32B 27/06

(52) U.S. Cl. 428/458; 428/473.5

(57) ABSTRACT

Provided are a multilayer polyimide film that hardly suffers from the peeling of the layers from each other or the clouding of a space between the layers (turning white in color) during heating at a high temperature and a flexible metal-clad laminate using such a multilayer polyimide film. This object can be attained by a multilayer polyimide film having a thermoplastic polyimide layer on at least one side of a nonthermoplastic polyimide layer, wherein at least 60% of the total number of moles of an acid dianhydride monomer and a diamine monomer that constitute the thermoplastic polyimide is the same type of monomer as at least one type of acid dianhydride monomer and at least one type of diamine monomer that constitute the nonthermoplastic polyimide.

### TECHNICAL FIELD

The present invention relates to multilayer polyimide films and flexible metal-clad laminates that can be suitably used for flexible printed wiring boards.

### BACKGROUND ART

In recent years, along with a reduction in weight, a reduction in size, and an increase in density of electronics products, there has been a growing demand for various printed boards. In particular, there has been a rapidly growing demand for flexible laminates (referred to also as “flexible printed wiring boards (FPCs)”). A flexible laminate has such a structure that a circuit made of a metal layer is formed on an insulating film such as a polyimide film.

The flexible printed wiring board starts from a flexible metal-clad laminate. In general, a flexible metal-clad laminate is produced by a method for, by using as a substrate an insulating film made of various insulating materials and having flexibility, bonding a sheet of metal foil onto a surface of the substrate via various adhesive materials by heating and pressure bonding. As the insulating film, a polyimide film or the like is preferably used. As the adhesive material, a thermosetting adhesive such as an epoxy adhesive or an acrylic adhesive is generally used.

A thermosetting adhesive has an advantage of allowing for adhesion at a comparatively low temperature. However, along with stricter requirements for properties such as heat resistance, bendability, electric reliability, a three-layer FPC with a thermosetting adhesive is expected to have difficulty in satisfying these requirements. For this reason, a two-layer FPC has been proposed which is obtained by providing a metal layer directly on an insulating film or whose adhesive layer is made of a thermoplastic polyimide. Such two-layer FPCs, which are superior in properties to three-layer FPCs, are expected to experience an increase in demand in the future.

Examples of a method for producing a multilayer polyimide film are as follows: a method for producing a multilayer polyimide film by heating at a high temperature after applying a thermoplastic polyamic acid solution onto and drying it on a polyimide film produced in advance (see Patent Literature 1); a method for producing a multilayer polyimide film by heating at a high temperature after repeating application of a polyamic acid solution onto and drying of it on a sheet of metal foil (hereinafter, solution casting) (see Patent Literatures 2 and 4); and a method for producing a multilayer polyimide film by heating at a high temperature by removing a gel film from a support such as a drum or an endless belt after simultaneously applying a multilayer polyamic acid onto and drying it on the support by multilayer extrusion (hereinafter, multilayer extrusion) (see Patent Literature 3).

Whether in the case of solution casting or multilayer extrusion, a solvent, water, or the like from an internal layer passes through the outermost layer during heating at a high temperature. However, in a case where the rate of discharge of the solvent, the water, or the like from the internal layer is faster than the rate of passage of the solvent, the water, or the like through the outermost layer, the solvent, the water, or the like accumulates between the internal layer and the outermost layer to cause the layers to peel from each other or cause a space between the layers to become clouded (turn white in color).

Therefore, there has been a market demand for multilayer polyimide films that hardly suffer from the peeling of the layers from each other or the clouding of a space between the layers (turning white in color, hereinafter referred to sometimes as “whitening” in this specification).

### CITATION LIST

### Patent Literature 1

Japanese Patent Application Publication, Tokukaihei, No. 8-197695 (Publication Date: Aug. 6, 1996)

### Patent Literature 2

Japanese Patent No. 2746555 (Publication Date: May 6, 1998)

### Patent Literature 3

Japanese Patent Application Publication, Tokukai, No. 2006-297821 (Publication Date: Nov. 2, 2006)

### Patent Literature 4

Japanese Patent Application Publication, Tokukai, No. 2006-321229 (Publication Date: Nov. 30, 2006)

### SUMMARY OF INVENTION

### Technical Problem

The present invention has been made in view of the foregoing problems, and it is an object of the present invention to provide a multilayer polyimide film that hardly suffers from the peeling of the layers from each other or the clouding of a space between the layers (turning white in color) during heating at a high temperature and a flexible metal-clad laminate using such a multilayer polyimide film.

### Solution to Problem

As a result of their diligent study in view of the foregoing problems, the inventors of the present invention attained the present invention.

That is, the present invention relates to a multilayer polyimide film having a thermoplastic polyimide layer on at least one side of a nonthermoplastic polyimide layer, wherein at least 60% of the total number of moles of an acid dianhydride monomer and a diamine monomer that constitute the thermoplastic polyimide is the same type of monomer as at least one type of acid dianhydride monomer and at least one type of diamine monomer that constitute the nonthermoplastic polyimide.

### Advantageous Effects of Invention

The present invention makes it possible to provide a multilayer polyimide film that hardly suffers from the peeling of the layers from each other or the clouding of a space between the layers (turning white in color) during heating at a high temperature and a flexible metal-clad laminate using such a multilayer polyimide film.

### DESCRIPTION OF EMBODIMENTS

An embodiment of the present invention is described below.

The present invention relates to a multilayer polyimide film having a thermoplastic polyimide layer on at least one side of a nonthermoplastic polyimide layer, wherein at least 60% of the total number of moles of an acid dianhydride monomer and a diamine monomer that constitute the thermoplastic polyimide is the same type of monomer as at least one type of acid dianhydride monomer and at least one type of diamine monomer that constitute the nonthermoplastic polyimide. The proportion of an acid dianhydride and a diamine that are used in the nonthermoplastic polyimide is calculated on the basis of an acid dianhydride and a diamine that are used in the thermoplastic polyimide. The calculation method is as follows: the total number of moles of the acid dianhydride and the diamine that are used in the thermoplastic polyimide is calculated (total number of moles); next, the number of moles of the acid dianhydride and the diamine that constitute the thermoplastic polyimide and that are used in the nonthermoplastic polyimide is calculated (number of moles of the same type); and finally, the proportion of the acid dianhydride and the diamine that are used in the nonthermoplastic polyimide is calculated on the basis of the acid dianhydride and the diamine that are used in the thermoplastic polyimide according to (Number of moles of the same type)/(Total number of moles).

At least 60%, more preferably at least 70%, or even more preferably at least 80% of the total number of moles of the acid dianhydride monomer and the diamine monomer that constitute the thermoplastic polyimide is the same type of monomer as the at least one type of acid dianhydride monomer and the at least one type of diamine monomer that constitute the nonthermoplastic polyimide.

Examples of a method for producing a multilayer polyimide film are as follows: [1] a method for producing a multilayer polyimide film by heating at a high temperature after applying a thermoplastic polyamic acid solution onto and drying it on a polyimide film produced in advance; [2] a method for producing a multilayer polyimide film by heating at a high temperature after repeating application of a polyamic acid solution onto and drying of it on a sheet of metal foil (hereinafter, solution casting); and [3] a method for producing a multilayer polyimide film by heating at a high temperature by removing a gel film from a support such as a drum or an endless belt after simultaneously applying a multilayer polyamic acid onto and drying it on the support by multilayer extrusion (hereinafter, multilayer extrusion). The term “heating at a high temperature” here means heating at 80° C. or higher.

Whether in the case of solution casting or multilayer extrusion, a solvent, water, or the like from an internal layer passes through the outermost layer during heating at a high temperature. However, in a case where the rate of discharge of the solvent, the water, or the like from the internal layer is extremely faster than the rate of passage of the solvent, the water, or the like through the outermost layer, the solvent, the water, or the like accumulates between the internal layer and the outermost layer to cause the layers to peel from each other or cause a space between the layers to become clouded (turn white in color). Further, if the rate of imidization of the internal layer is extremely faster than that of the outermost layer, the adhesion between the internal layer and the outermost layer decreases, with the result that the layers peel from each other or a space between the layers becomes clouded (turns white in color). It was found that the higher is the proportion in which the acid dianhydride and the diamine that are used in the nonthermoplastic polyimide layer and those which are used in the thermoplastic polyimide layer are the same, the more likely it is for the solvent, the water, or the like discharged from the internal layer to be discharged from the outermost layer at the same level, and that because of the similarity in structure, the adhesion between the internal layer and the outermost layer improves. In particular, in the case of multilayer extrusion, the amount of discharge of the solvent, the water, or the like from the internal layer is so large that the foregoing problems often notably occur.

As a result of their diligent study in view of the foregoing problems, the inventors of the present invention found the peeling of the layers from each other or the clouding of a space between the layers (turning white in color) during heating at a high temperature is lessened by a multilayer polyimide film having a thermoplastic polyimide layer on at least one side of a nonthermoplastic polyimide layer, wherein at least 60% of the total number of moles of an acid dianhydride monomer and a diamine monomer that constitute the thermoplastic polyimide is the same type of monomer as at least one type of acid dianhydride monomer and at least one type of diamine monomer that constitute the nonthermoplastic polyimide. Thus, the inventors of the present invention attained the present invention.

Examples of an aromatic acid dianhydride that is used in the nonthermoplastic polyimide layer and the thermoplastic polyimide layer of the multilayer polyimide film include, but are not particularly limited to, pyromellitic acid dianhydride, 2,3,6,7-naphthalenetetracarboxylic acid dianhydride, 3,3′,4,4′-biphenyltetracarboxylic acid dianhydride, 1,2,5,6-naphthalenetetracarboxylic acid dianhydride, 2,2′,3,3′-biphenyltetracarboxylic acid dianhydride, 3,3′,4,4′-benzophenonetetracarboxylic acid dianhydride, 2,2-bis(3,4-dicarboxyphenyl)propane dianhydride, 3,4,9,10-perylenetetracarboxylic acid dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, oxydiphthalic acid dianhydride, bis(3,4-dicarboxyphenyl)sulfone dianhydride, p-phenylene bis(trimellitic acid monoester acid anhydride), ethylene bis(trimellitic acid monoester acid anhydride), bisphenol A bis(trimellitic acid monoester acid anhydride), and derivative thereof. These aromatic acid dianhydrides can be favorably used alone or in the form of a mixture thereof with a given ratio. Among them, it is preferable that the acid dianhydride monomer that constitutes the thermoplastic polyimide be at least one type of acid dianhydride selected from the group consisting of pyromellitic acid dianhydride, 3,3′,4,4′-biphenyltetracarboxylic acid dianhydride, and 3,3′,4,4′-benzophenonetetracarboxylic acid dianhydride. In terms of balance between the ease with which a metal-clad laminate is produced by heat roller lamination and the peel-strength of the metal layer and the multilayer polyimide film of the metal-clad laminate, it is especially preferable that at least either pyromellitic acid dianhydride or 3,3′,4,4′-biphenyltetracarboxylic acid dianhydride be used.

Examples of an aromatic diamine that is used in the nonthermoplastic polyimide layer and the thermoplastic polyimide layer of the multilayer polyimide film include, but are not particularly limited to, 4,4′-diaminodiphenylether, 3,4′-diaminodiphenylether, 1,3-bis(4-aminophenoxy)benzene, 1,4-bis(4-aminophenoxy)benzene, p-phenylenediamine, 4,4′-diaminodiphenylpropane, 4,4′-diaminodiphenylmethane, benzidine, 3,3′-dichlorobenzidine, 4,4′-diaminodiphenyl sulfide, 3,3′-diaminodiphenylsulfone, 4,4′-diaminodiphenylsulfone, 4,4′-diaminodiphenylether, 3,3′-diaminodiphenylether, 3,4′-diaminodiphenylether, 1,5-diaminonaphthalene, 4,4′-diaminodiphenyldiethyl silane, 4,4′-diaminodiphenyl silane, 4,4′-diaminodiphenylethylphosphine oxide, 4,4′-diaminodiphenyl-N-methylamine, 4,4′-diaminodiphenyl N-phenylamine, 1,4-diaminobenzene(p-phenylenediamine), 1,3-diaminobenzene, 1,2-diaminobenzene, 2,2-bis[4-(4-aminophenoxy)phenyl]propane, and derivatives thereof. These aromatic diamines can be favorably used alone or in the form of a mixture thereof with a given ratio. Among them, it is preferable that the diamine monomer that constitutes the thermoplastic polyimide be 4,4′-diaminodiphenylether or 2,2-bis[4-(4-aminophenoxy)phenyl]propane.

In terms of suppressing bulging during soldering in a hygroscopic state, it is especially preferable in the present invention that the acid dianhydride that constitutes the thermoplastic polyimide be pyromellitic acid dianhydride and that the diamine that constitutes the thermoplastic polyimide be 2,2-bis[4-(4-aminophenoxy)phenyl]propane.

Further, in view of the high peel-strength of the sheet of metal foil after the processing of a metal-clad laminate, it is preferable that 3,3′,4,4′-biphenyltetracarboxylic acid dianhydride be used as the acid dianhydride that constitutes the thermoplastic polyimide.

Furthermore, it is more preferable that a combination of pyromellitic acid dianhydride and 3,3′,4,4′-biphenyltetracarboxylic acid dianhydride be used as the acid dianhydride that constitutes the thermoplastic polyimide. This makes it possible to satisfy both metal foil peel-strength and soldering heat resistance. In a case where the acid dianhydride monomer that constitutes the thermoplastic polyimide is a combination of pyromellitic acid dianhydride and 3,3′,4,4′-biphenyltetracarboxylic acid dianhydride, it is preferable that examples of the diamine monomer that constitutes the thermoplastic polyimide include, but be not particularly limited to, 2,2-bis[4-(4-aminophenoxy)phenyl]propane.

In a case where a combination of pyromellitic acid dianhydride and 3,3′,4,4′-biphenyltetracarboxylic acid dianhydride is used as the acid dianhydride that constitutes the thermoplastic polyimide, the ratio between pyromellitic acid dianhydride and 3,3′,4,4′-biphenyltetracarboxylic acid dianhydride be preferably 70/30 to 95/5 or more preferably 75/25 to 95/5 in mole ratio, especially in order that both metal foil peel-strength and soldering heat resistance are suitably satisfied.

A preferred solvent for synthesizing polyamic acid in the present invention may be any solvent that dissolves polyamic acid, but examples can include amide solvents, i.e., N,N-dimethylformamide, N,N-dimethylacetoamide, N-methyl-2-pyrrolidone, etc. Among them, N,N-dimethylformamide and N,N-dimethylacetoamide can be especially preferably used.

The term “nonthermoplastic polyimide” in the present invention generally means a polyimide that does not soften or exhibit adhesiveness even when heated. In the present invention the term means a polyimide that does not get wrinkled or elongated and maintains its shape even when heated at 380° C. for 2 minutes in the form of a film, or a polyimide that has substantially no glass transition temperature.

Further, the term “thermoplastic polyimide” generally means a polyimide that has a glass transition temperature in DSC (differential scanning calorimetry). The term “thermoplastic polyimide” in the present invention means a thermoplastic polyimide whose glass transition temperature ranges from 150° C. to 350° C.

For polymerization of a nonthermoplastic polyamic acid in the present invention, any method for adding a monomer may be used. Representative examples of the polymerization method are as follows:

(1) A method for dissolving an aromatic diamine in an organic polar solvent and causing the aromatic diamine to react with a substantially equimolar amount of an aromatic tetracarboxylic acid dianhydride for polymerization;

(2) A method for causing an aromatic tetracarboxylic acid dianhydride and a smaller molar amount of an aromatic diamine compound to react in an organic polar solvent, thereby forming a prepolymer having acid anhydride groups at both terminals, and then using the aromatic diamine compound for polymerization so that the aromatic tetracarboxylic acid dianhydride and the aromatic diamine compound are substantially equal in mole with the amounts in all steps being considered together;

(3) A method for causing an aromatic tetracarboxylic acid dianhydride and an excessive molar amount of an aromatic diamine compound to react in an organic polar solvent, thereby forming a prepolymer having amino groups at both terminals, and then, after adding the aromatic diamine compound to the prepolymer, and using the aromatic tetracarboxylic acid dianhydride for polymerization so that the aromatic tetracarboxylic acid dianhydride and the aromatic diamine compound are substantially equal in mole with the amounts in all steps being considered together;

(4) A method for, after dissolving and/or dispersing an aromatic tetracarboxylic acid dianhydride in an organic polar solvent, using an aromatic diamine compound for polymerization so that the aromatic tetracarboxylic acid dianhydride and the aromatic diamine compound are substantially equal in mole; and

(5) A method for causing a mixture of an aromatic tetracarboxylic acid dianhydride and an aromatic diamine that are substantially equal in mole to react in an organic polar solvent for polymerization.

These methods may be used alone or can be used by being partially combined.

In particular, it is preferable that the nonthermoplastic polyamic acid be obtained through the following steps (a) to (c) of:

(a) causing an aromatic acid dianhydride and an excessive molar amount of an aromatic diamine to react in an organic polar solvent, thereby forming a prepolymer having amino groups at both terminals;

(b) then further adding the aromatic diamine to the prepolymer; and

(c) further adding the aromatic acid dianhydride for polymerization so that the aromatic acid dianhydride and the aromatic diamine are substantially equal in mole with the amounts in all steps being considered together.

The polyamic acid obtained by the method is imidized to form a multilayer polyimide film.

A method for producing a thermoplastic polyamic acid that is used for producing a thermoplastic polyimide preferably includes the step (a) of causing an aromatic acid dianhydride and an excessive amount of an aromatic diamine to react in an organic polar solvent, thereby forming a prepolymer having amino groups at both terminals and the step (b) of then adding the aromatic acid dianhydride for polymerization so that the ratio between the aromatic acid dianhydride and the aromatic diamine throughout all steps is a predefined ratio. In the step (b), examples of the method for adding the aromatic acid dianhydride include a method for inputting a powder, a method for inputting an acid solution obtained by dissolving an acid dianhydride in advance in an organic polar solvent, etc. For the reaction to proceed uniformly, the method for inputting an acid solution is preferred.

It is preferable that the solid-content concentrations of the nonthermoplastic polyamic acid and the thermoplastic polyamic acid during polymerization range from 10 to 30% by weight. The solid-content concentration can be determined according to the rate of polymerization and the viscosity of polymerization. The viscosity of polymerization can be set in accordance with a case of coating of a support film with a polyamic acid solution of the thermoplastic polyimide or a case of coextrusion with the nonthermoplastic polyimide. However, in the case of coating, it is preferable that the viscosity of polymerization be equal to or less than 100 poise for example at a solid-content concentration of 14% by weight. Further, in the case of coextrusion, it is preferable that the viscosity of polymerization range from 100 poise to 1200 poise for example at a solid-content concentration of 14% by weight. For the resulting multilayer polyimide film to have a uniform thickness, it is more preferable that the viscosity of polymerization range from 150 poise to 800 poise for example at a solid-content concentration of 14% by weigh The aromatic acid dianhydride and the aromatic diamine can be used in a different order in consideration of the properties and productivity of the multilayer polyimide film.

Further, for the purpose of improving the properties of the film, such as slidability, thermal conductivity, electric conductivity, corona resistance, it is possible to add a filler to the nonthermoplastic polyamic acid and the thermoplastic polyamic acid. Preferred examples of the filler include, but are not particularly limited to, silica, titanium oxide, alumina, silicon nitride, boron nitride, calcium hydrogen phosphate, calcium phosphate, mica, etc.

The particle diameter of the filler is determined according to the film properties to be modified and the type of filler to be added, and as such, is not to be particularly limited. However, in general, the average particle diameter ranges from 0.05 to 20 μm, preferably from 0.1 to 10 μm, more preferably from 0.1 to 7 μm, or especially preferably from 0.1 to 5 μm. If the particle diameter falls short of this range, a modifying effect is hardly seen. If the particle diameter exceeds this range, there may be a great impairment in surface properties or a great decrease in mechanical properties. Further, the number of parts of the filler to be added is also determined according to the film properties to be modified and the filler particle diameter, and as such, is not to be particularly limited. In general, the amount of a filler to be added ranges from 0.01 to 50 parts by weight, preferably 0.01 to 20 parts by weight, or more preferably 0.02 to 10 parts by weight with respect to 100 parts by weight of polyimide. If the amount of the filler to be added falls short of this range, a modifying effect is hardly brought about by the filler. If the amount of the filler to be added exceeds this range, there may be a great impairment in mechanical properties of the film.

The filler may be added, for example, by any method such as the following methods:

(1) A method for adding the filler to a polymerization reaction liquid before or during polymerization;

(2) A method for kneading the filler by using a three-piece roller or the like after completion of polymerization;

(3) A method for preparing a dispersion liquid containing the filler and mixing the dispersion liquid into a polyamic acid organic solvent solution; and

(4) A method for dispersing the filler by a bead mill or the like.

However, the method for mixing a dispersion liquid containing the filler into a polyamic acid solution or, in particular, a method for mixing a dispersion liquid containing the filler into a polyamic acid solution immediately before film formation is preferred because the method best prevents the filler from contaminating a production line.

In preparing a dispersion liquid containing the filler, it is preferable to use the same solvent as the solvent for polymerization of the polyamic acid. Further, for satisfactory dispersion of the filler and a stable dispersion state, it is possible to use a dispersing agent, a thickening agent, or the like within such a range as not to affect the film properties.

In a case where the filler is added to improve the slidability of the film, the particle diameter ranges from 0.1 to 10 μm or preferably from 0.1 to 5 μm. If the particle diameter falls short of this range, an effect of improving slidability is hardly seen. If the particle diameter exceeds this range, it tends to become difficult to create a fine wiring pattern. Furthermore, in this case, the dispersion state of the filler is important: The filler should not form more than fifty 20-μm or lager aggregates per square meter or, preferably, should not form more than forty 20-μm or lager aggregates per square meter. If the number of 20-μm or lager aggregates of filler exceeds this range, the aggregates of filler may lead to cissing during adhesive coating, or may produce a reduction in joining area when a high-definition wiring pattern is created, thus tending to degrade the insulation reliability of a flexible printed board per se.

In the present invention, it is important to obtain a multilayer film including a solution layer (a) containing at least a thermoplastic polyimide and/or a precursor to thermoplastic polyimide and a solution layer (b) containing a nonthermoplastic polyimide precursor. Any method may be employed as long as it is capable of forming a state in which the solution layers are stacked; however, a multilayer film of polyimide precursors may be obtained, for example, by a method such as solution casting or multilayer extrusion (coextrusion-casting method) with use of the solutions (a) and (b).

The following describes a coextrusion-casting method including the step of flow casting on a support by multilayer coextrusion. The term “multilayer coextrusion” means a method for producing a film including the step of feeding a polyamic acid solution simultaneously to a multilayer die having two or more layers and extruding the solution via outlets of the die onto a support in the form of at least two thin films.

To explain a commonly used method, the solution extruded from the multilayer die having two or more layers is continuously extruded onto a flat and smooth support, and then at least part of the solvent in the form of multiple thin films on the support is volatilized, whereby a multilayer film having a self-supporting property is obtained. It is preferable that the coating film of the support be heated at a maximum temperature of 100 to 200° C.

Furthermore, the multilayer film is removed from the support, and finally, the multilayer film is sufficiently treated with heat at a high temperature (250 to 600° C.) so that the solvent is substantially eliminated and the progression of imidization is allowed, whereby a multilayer polyimide film is obtained. The multilayer film removed from the support is in an intermediate stage of curing from polyamic acid to polyimide and has a self-supporting property, and the content of volatile portions ranges from 5 to 200% by weight, preferably from 10 to 100% by weight, or more preferably from 30 to 80% by weight. The content of volatile portions is calculated from formula (1):

(A−B)×100/B (1),

where A is the weight of the multilayer film and B is the weight of the multilayer film after heating at 450° C. for 20 minutes. A film falling within this range is suitably used. Within this range, there is only a remote possibility of problems such as breakage of the film in the process of calcination, unevenness of color tone of the film due to unevenness of drying, and variations in properties. Further, for the purpose of improving the molten flowability of the adhesive layer, the rate of imidization may be intentionally lowered and/or the solvent may be intentionally allowed to remain.

In the present invention, the support is the one onto which the multilayer liquid film extruded from the multilayer die is cast, on which the multilayer liquid film is dried by heating, and which imparts a self-supporting property to the multilayer liquid film. The support can take any shape; however, in consideration of the productivity of adhesive films, it is preferable that the support take the shape of a drum or a belt. Further, the support may be made of any material, examples of which include metal, plastic, glass, ceramic, etc., preferably metal, or more preferably SUS material, which has great resistance to corrosion. Further, the support may be plated with metal such as Cr, Ni, and Sn.

In general, polyimide is obtained by a dehydration shift reaction from a precursor to polyimide, i.e., polyamic acid. There are two most widely known methods for shift reaction: a heat curing method for shift reaction solely by heat and a chemical curing method for shift reaction with use of a chemical dehydrating agent (hereinafter referred to simply as “dehydrating agent” in this specification). The chemical curing method is more preferably employed because it is superior in productivity.

A “chemical curing agent” (hereinafter referred to simply as “curing agent” in this specification) here means the one which contains a dehydrating agent and a catalyst. The dehydrating agent here is a dehydrating and ring-closing agent for polyamic acid, and can be preferably composed mainly of an aliphatic acid anhydride, an aromatic acid anhydride, N,N′-dialkylcarbodiimide, a lower aliphatic halide, a halogenated lower aliphatic acid anhydride, dihalide arylsulfonate, thionyl halide, or a mixture of two or more of them. Among them, an aliphatic acid anhydride and an aromatic acid anhydride exhibit satisfactory action. Further, the catalyst is a component having an effect of facilitating the dehydrating and ring-closing action of the dehydrating agent for polyamic acid, and usable examples of the catalyst include aliphatic tertiary amines, aromatic tertiary amines, and heterocyclic tertiary amines. Among them, a nitrogen-containing heterocyclic compound such as imidazole, benzimidazole, isoquinoline, quinoline, or β-picoline is more preferred. Furthermore, the introduction of an organic polar solvent into a solution composed of the dehydrating agent and the catalyst can be selected as needed.

In a case where the chemical curing method is employed, it is preferable that the dehydrating agent and the catalyst be contained in at least either of the solutions (a) and (b). In particular, it is preferable that the dehydrating agent and the catalyst be contained in the solution (b). When the dehydrating agent and the catalyst are contained in the solution (a), the properties of the adhesive layer containing the thermoplastic polyimide may not be fully utilized in some cases. However, use of the solution (a) is not to be excluded. It is more preferable that the dehydrating agent and the catalyst be contained solely in the solution (b). A method for causing the dehydrating agent and the catalyst to be contained solely in one solution layer is preferred because the method leads to simplification of production facilities. As a result of their study, the inventors of the present invention found that the inclusion of the dehydrating agent and the catalyst in the solution (b) imparts sufficient properties to the resulting multilayer polyimide film. Therefore, it is most preferable that the dehydrating agent and the catalyst be contained solely in the solution (b).

The content of the chemical dehydrating agent ranges preferably from 0.5 to 4.0 mol, more preferably from 1.0 to 3.0 mol, or even more preferably from 1.2 to 2.5 mol with respect to 1 mol of amide acid unit in polyamic acid contained in the solution in which the chemical dehydrating agent and the catalyst are to be contained.

For the same reason, the content of the catalyst ranges preferably from 0.05 to 2.0 mol, more preferably from 0.05 to 1.0 mol, or even more preferably from 0.3 to 0.8 mol with respect to 1 mol of amide acid unit in polyamic acid contained in the solution in which the chemical dehydrating agent and the catalyst are to be contained.

Further, in order for the multilayer polyimide film to have a uniform thickness, it is preferable that the timing of mixing of the dehydrating agent and the catalyst into the polyamic acid be immediately before the mixture is inputted into the multilayer die.

There are no particular limitations on how to volatilize the solvent contained in at least three or at least two thin films extruded from the multilayer die, but the easiest way is to volatilize the solvent by heating and/or blowing. It is preferable that the heating be carried out at a temperature lower than the boiling point of the solvent used plus 50° C., because too high a temperature causes the solvent to quickly volatilize and such volatilization leaves traces that cause minute defects to be formed in the resulting adhesive film.

The duration of imidization is not to be unambiguously limited. It is only necessary to take a sufficient time for imidization and drying to be substantially completed. In general, in a case where the chemical curing method is employed, the duration of imidization is appropriately set within the range of 1 to 600 seconds, and in a case where the heat curing method is employed, the duration of imidization is appropriately set within the range of 60 to 1800 seconds.

The tension to be applied during imidization ranges preferably from 1 kg/m to 15 kg/m or especially preferably from 5 kg/m to 10 kg/m. If the tension falls short of the range, a sag or meandering in the film during conveyance may lead to problems such as the film getting wrinkled during winding and the film being unable to be evenly wound. On the other hand, if the tension exceeds the range, the film is heated at a high temperature with a high tension applied to the film. This may debase the dimensional properties of a metal-clad laminate that is fabricated using a substrate for a metal-clad laminate.

The multilayer die used may be of various structures. For example, a T die for creating films for multiple layers or the like can be used. Alternatively, it is possible to suitably use a die of any of the conventionally known structures, and especially suitably usable examples include a feed block T die and a multi-manifold T die

A method for producing a flexible metal-clad laminate according to the present invention is described below, but is not to be limited to this.

It is preferable that the method for producing a flexible metal-clad laminate according to the present invention include the step of bonding a sheet of metal foil to the multilayer polyimide film. As a sheet of copper foil to be used in the flexible metal-clad laminate, a sheet of copper foil having a thickness of 1 to 25 μm can be used, and a sheet of rolled copper foil or a sheet of electrolytic copper foil may be used.

A usable example of a method for bonding a sheet of metal foil to the multilayer polyimide film is continuous processing by a heat roller laminating apparatus having one or more pairs of metal rollers or by a double belt press (DBP). Among them, the heat roller laminating apparatus having one or more pairs of metal rollers is preferably used because the apparatus is simple in configuration and advantageous in term of maintenance cost.

The term “heat roller laminating apparatus having one or more pairs of metal rollers” needs only mean an apparatus having metal rollers for heating and pressing a material, and a specific configuration of the apparatus is not to be particularly limited.

It should be noted that the step of bonding a sheet of metal foil to the multilayer polyimide film is hereinafter referred to as “heat laminating step”.

A specific configuration of means for executing the heat laminating step (such means being hereinafter referred to sometimes as “heat laminating means” in this specification) is not to be particularly limited; however, in order for the resulting laminate to have a satisfactory appearance, it is preferable that a protection material be placed between the pressurized surface and the sheet of metal foil.

Examples of the protection material include materials that can withstand the heating temperature of the heat laminating step, e.g., heat-resistant plastic such as a nonthermoplastic polyimide film and metal foil such as copper foil, aluminum foil, and SUS foil. Among them, a nonthermoplastic polyimide film or a film made of a thermoplastic polyimide whose glass transition temperature (Tg) is 50° C. or more higher than the laminating temperature is preferred because of its excellent balance between heat resistance, reusability, etc. In the case of use of a thermoplastic polyimide, selection of a thermoplastic polyimide that satisfies the above condition makes it possible to prevent the thermoplastic polyimide from adhering to the rollers.

Further, when the protection material is thin in thickness, the protection material does not sufficiently fulfill its role as buffering and protection during lamination. Therefore, it is preferable that the nonthermoplastic polyimide film have a thickness of 75 μm or greater.

Further, the protection material does not need to be a single layer, but may be a multilayer structure having two or more layers with different properties.

Further, in a case where the laminating temperature is a high temperature, direct use of the protection material for lamination may lead to a rapid thermal expansion that undermines the appearance and dimensional stability of the resulting flexible metal-clad laminate. Therefore, it is preferable that the protection material be subjected to preheating before lamination. In such a case of lamination after preheating of the protection material, the influence on the appearance and dimensional properties of the flexible metal-clad laminate is curbed since the protection material has finished thermally expanding.

An example of preheating means is a method for bringing the protection material into contact with a heating roller, for example, by holding the protection material on the heating roller. The duration of contact is preferably 1 second or longer or more preferably 3 seconds or longer. If the duration of contact is shorter than that, the lamination is carried out before the protection material finishes thermally expanding. This causes a rapid thermal expansion in the protection material during lamination, thus debasing the appearance and dimensional properties of the resulting flexible metal-clad laminate. The distance for which the protection material is held on the heating roller is not particularly limited, but may be adjusted as needed on the basis of the diameter of the heating roller and the duration of contact.

A method by which the materials to be laminated are heated in the heat laminating means is not to be particularly limited, and it is possible to use heating means employing a conventionally publicly known method that allows for heating at a predetermined temperature, such as a heat circulation method, a hot-air heating method, or an induction heating method. Similarly, a method by which the materials to be laminated are pressurized in the heat laminating means is not to be particularly limited, either, and it is possible to use pressurizing means employing a conventionally publicly known method that allows for application of a predetermined pressure, such as a hydraulic method, an air pressure method, or an inter-gap pressure method.

The heating temperature during the heat laminating step, i.e., the laminating temperature is preferably a temperature equal to or higher than the glass transition temperature (Tg) of the multilayer polyimide film plus 50° C. or more preferably a temperature equal to or higher than Tg of the multilayer polyimide film plus 100° C. At a temperature equal to or higher than Tg+50° C., the multilayer polyimide film and the sheet of metal foil can be satisfactorily laminated by heat. Alternatively, at a temperature equal to or higher than Tg+100° C., the productivity of laminates by thermal lamination can be improved by raising the rate of lamination.

In particular, since the polyimide film used as a core of the multilayer polyimide film of the present invention is designed so that thermal stress relaxation is effective in the case of lamination at Tg+100° C. or higher, a flexible metal-clad laminate having great dimensional stability is obtained with high productivity.

The duration of contact with the heating roller is preferably 0.1 second or longer, more preferably 0.2 second or longer, or especially preferably 0.5 second or longer. If the duration of contact is falls short of the range, a sufficient relaxation effect may not be brought about. A preferred upper limit to the duration of contact is 5 second or shorter. Contact longer than 5 seconds is not preferred, because it does not bring about a greater relaxation effect, leads to a decrease in rate of lamination, and places restrictions on the layout of the line.

Further, even when slowly cooled in contact with the heating roller after lamination, the flexible metal-clad laminate still has a great difference in temperature from room temperature, and in some case, the residual strain may not have been completely relieved. For this reason, it is preferable that the flexible metal-clad laminate after slow cooling in contact with the heating roller be subjected to a postheat step with the protection material placed thereon. It is preferable that the tension during the postheat step range from 1 to 10 N/cm. Further, it is preferable that the ambient temperature during postheating range from (Temperature of flexible metal-clad laminate after slow cooling −200° C.) to (Laminating temperature +100° C.).

The term “ambient temperature” here means the temperature of the external surface of the protection material in close contact with both surfaces of the flexible metal-clad laminate. Although the actual temperature of the flexible metal-clad laminate varies somewhat depending on the thickness of the protection material, setting the temperature of the surface of the protection material within the range makes it possible to bring about the effects of postheating. Measurement of the temperature of the external surface of the protection material can be performed by using a thermocouple, a thermometer, or the like.

The rate of lamination in the heat laminating step is preferably 0.5 m/min or higher or more preferably 1.0 m/min or higher. At a rate of lamination of 0.5 m/min or higher, sufficient thermal lamination becomes possible. Furthermore, at a rate of lamination of 1.0 m/min or higher, a further improvement in productivity can be brought about.

As for the pressure during the heat laminating step, i.e., the laminating pressure, there is such an advantage that the higher the laminating pressure is, the lower the laminating temperature and the higher the rate of lamination can be made. However, in general, too high a laminating pressure tends to aggravate a change in dimension of the resulting laminate. On the other hand, too low a laminating pressure leads to a decrease in adhesive strength of the sheet of metal foil of the resulting laminate. For this reason, it is preferable that the laminating pressure fall within the range of 49 to 490 N/cm (5 to 50 kgf/cm), or more preferably 98 to 294 N/cm (10 to 30 kgf/cm). Within this range, the three conditions, namely the laminating temperature, the rate of lamination, and the laminating pressure, can be satisfied, so that a further improvement in productivity can be brought about.

It is preferable that the tension of the adhesive film in the laminating step fall within the range of 0.01 to 4 N/cm, more preferably 0.02 to 2.5 N/cm, or especially preferably 0.05 to 1.5 N/cm. If the tension falls short of this range, a sag or meandering in the laminate during conveyance makes it impossible for the laminate to be evenly fed to the heating roller, thus making it difficult to obtain a flexible metal-clad laminate having a satisfactory appearance. On the other hand, if the tension exceeds the range, the tension exerts such a strong influence that cannot be alleviated by controlling Tg and the modulus of storage elasticity of the adhesive layer, thus bringing about deterioration in dimensional stability.

A flexible metal-clad laminate according to the present invention is preferably obtained by using a heat laminating apparatus that continuously carries out heating pressure bonding of the materials to be laminated. Furthermore, in such a heat laminating apparatus, material-to-be-laminated unreeling means for unreeling the materials to be laminated may be provided in front of the heat laminating means, and material-to-be-laminated winding means for winding the materials to be laminated may be provided behind the heat laminating means. Provision of these means can bring about a further improvement in productivity of the heat laminating apparatus.

Possible examples of specific configurations of the material-to-be-laminated unreeling means and the material-to-be-laminated winding means include, but are not particularly limited to, a publicly known roll winding machines, etc. capable of winding the adhesive film, the sheet of metal foil, or the resulting laminate.

Furthermore, it is more preferable that protection material winding means and protection material unreeling means for winding and unreeling the protection material be provided. Provision of the protection material winding means and the protection material unreeling means makes it possible to reuse the protection material in the heat laminating step by winding the protection material after use and placing it on the unreeling side again.

Further, edge position detecting means and winding position correcting means may be provided so that the protection material can be wound with each edge of the protection material aligned. This makes it possible to accurately wind the protection material with each edge aligned, thus making it possible to enhance the efficiency in the reuse of the protection material. It should be noted that the protection material winding means, the protection material unreeling means, the edge position detecting means, and the winding position correcting means are not to be particularly limited to specific configurations, but can be realized by various conventionally publicly known apparatuses.

A flexible metal-clad laminate according to the present invention needs only be obtained by bonding a sheet of metal foil to a multilayer polyimide film of the present invention, but it is more preferable that the peel-strength of the multilayer polyimide film and the sheet of metal foil of the metal-clad laminate be 10 N/cm or greater. In the case of occurrence of peeling or whitening between the layers of a multilayer polyimide film, the multilayer polyimide film has been susceptible to internal peeling. In the case of the flexible metal-clad laminate according to the present invention, the use of the multilayer polyimide film of the present invention, which hardly suffers from the peeling of the layers from each other or the clouding of a space between the layers (turning white in color), is believed to bring about at least such an effect that the multilayer polyimide film is unlikely to suffer from internal peeling. Further, the use of 3,3′,4,4′-biphenyltetracarboxylic acid dianhydride as the acid dianhydride that constitutes the thermoplastic polyimide of the multilayer polyimide film can bring about a further effect of making it possible to further improve the peel-strength of the sheet of metal foil after the processing of the metal-clad laminate.

In the case of measurement in a normal state, the temperature that the flexible metal-clad laminate according to the present invention can withstand during soldering is preferably 300° C. or higher, more preferably 320° C. or higher, even more preferably 330° C. or higher, or especially preferably 340° C. or higher. In the case of measurement after moisture absorption, the temperature that the flexible metal-clad laminate according to the present invention can withstand during soldering is preferably 250° C. or higher, more preferably 280° C. or higher, even more preferably 290° C. or higher, or especially preferably 300° C. or higher.

Conventionally, there has been proposed a flexible metal-clad laminate capable of withstanding a temperature of 300° C. during soldering. However, since polyimide has a high rate of moisture absorption, it has suffered from bulging during soldering in an actively hygroscopic state (e.g., Japanese Patent Application Publication, Tokukaihei, No. 9-116254 and Japanese Patent Application Publication, Tokukai, No. 2001-270037). Under such circumstances, there has been a market demand for a multilayer polyimide film that does not suffer from bulging during soldering in an actively hygroscopic state. According to the present invention, the use of pyromellitic acid dianhydride as the acid dianhydride that constitutes the thermoplastic polyimide of the multilayer polyimide film and 2,2-bis[4-(4-aminophenoxy)phenyl]propane as the diamine that constitutes the thermoplastic polyimide can bring about a further effect of making it possible to further suppress bulging during soldering in a hygroscopic state.

Furthermore, the use of a combination of pyromellitic acid dianhydride and 3,3′,4,4′-biphenyltetracarboxylic acid dianhydride as the acid dianhydride that constitutes the thermoplastic polyimide can bring about a further effect of making it possible to satisfy both metal foil peel-strength and soldering heat resistance.

That is, the present invention relates to a multilayer polyimide film having a thermoplastic polyimide layer on at least one side of a nonthermoplastic polyimide layer, wherein at least 60% of the total number of moles of an acid dianhydride monomer and a diamine monomer that constitute the thermoplastic polyimide is the same type of monomer as at least one type of acid dianhydride monomer and at least one type of diamine monomer that constitute the nonthermoplastic polyimide.

A preferred embodiment relates to the multilayer polyimide film characterized in that at least 80% of the total number of moles of the acid dianhydride monomer and the diamine monomer that constitute the thermoplastic polyimide is the same type of monomer as the at least one type of acid dianhydride monomer and the at least one type of diamine monomer that constitute the nonthermoplastic polyimide.

A preferred embodiment relates to the multilayer polyimide film characterized in that the acid dianhydride monomer that constitutes the thermoplastic polyimide is at least one type of acid dianhydride selected from the group consisting of pyromellitic acid dianhydride, 3,3′,4,4′-biphenyltetracarboxylic acid dianhydride, and 3,3′,4,4′-benzophenonetetracarboxylic acid dianhydride.

A preferred embodiment relates to the multilayer polyimide film characterized in that the diamine monomer that constitutes the thermoplastic polyimide is 4,4′-diaminodiphenylether or 2,2-bis[4-(4-aminophenoxy)phenyl]propane.

A preferred embodiment relates to the multilayer polyimide film characterized in that the acid dianhydride monomer that constitutes the thermoplastic polyimide is pyromellitic acid dianhydride, and the diamine monomer that constitutes the thermoplastic polyimide is 2,2-bis[4-(4-aminophenoxy)phenyl]propane.

A preferred embodiment relates to the multilayer polyimide film characterized in that the acid dianhydride monomer that constitutes the thermoplastic polyimide is a combination of pyromellitic acid dianhydride and 3,3′,4,4′-biphenyltetracarboxylic acid dianhydride, and the diamine monomer that constitutes the thermoplastic polyimide is 2,2-bis[4-(4-aminophenoxy)phenyl]propane.

A preferred embodiment relates to the multilayer polyimide film characterized in that the ratio between pyromellitic acid dianhydride and 3,3′,4,4′-biphenyltetracarboxylic acid dianhydride, which are acid dianhydride monomers that constitute the thermoplastic polyimide, is 70/30 to 95/5.

A preferred embodiment relates to the multilayer polyimide film characterized by being produced by multilayer coextrusion.

Further, the present invention relates to a flexible metal-clad laminate obtained by bonding a sheet of metal foil to the multilayer polyimide film described above.

### EXAMPLES

In the following, the present invention is specifically described by way of examples. However, the present invention is not to be limited solely to these examples. It should be noted that in Examples of Synthesis, Examples, and Comparative Example, the peel-strength of a multilayer polyimide film and a sheet of metal foil and soldering heat resistance were evaluated in the following manners.

### Method for Fabricating a Metal-Clad Laminate

A flexible metal-clad laminated was fabricated by placing 18 μm sheets of rolled copper foil (BHY-22B-T; manufactured by Nippon Mining & Metals Corporation) on both surfaces of a multilayer polyimide film, further placing a protective material (Apical 125NPI; manufactured by Kaneka Corporation) on both sides, and carrying out thermal lamination continuously at a laminating temperature of 380° C., under a laminating pressure of 196 N/cm (20 kgf/cm), and at a rate of lamination of 1.5 m/min with use of a heat roller laminating machine.

### Metal Foil Peel-Strength

In conformity to JIS C6471 “6.5 Peel-strength”, a sample was fabricated and the load at which a 5-mm-wide portion of metal foil was peeled from the sample at a peeling angle of 180 degrees and 50 mm/min was measured.

### Evaluation of Soldering Heat Resistance

Soldering heat resistance was measured in conformity to IPC-TM-650 No. 2.4.13. In the case of measurement in a normal state, the test piece was adjusted for 24 hours at 23° C./55% RH and then evaluated by being allowed to float for 30 seconds on a solder bath heated with increments of 10° C. in the range of 250° C. to 350° C. In the case of measurement in a hygroscopic state, the test piece was adjusted for 24 hours at 85° C./85% RH and then evaluated by being allowed to float for 10 seconds on a heated solder bath. In either case, the evaluated value is the maximum temperature at which no bulging occurred.

The following shows the abbreviated names of monomers and solvents that are used in Examples of Synthesis.

DMF: N,N-dimethylformamide

BAPP: 2,2-bis[4-(4-aminophenoxy)phenyl]propane

ODA: 4,4′-diaminodiphenylether

PDA: p-phenylenediamine

BPDA: 3,3′,4,4′-biphenyltetracarboxylic acid dianhydride

BTDA: 3,3′,4,4′-benzophenonetetracarboxylic acid dianhydride

PMDA: pyromellitic acid dianhydride

The following shows Example of Synthesis of polyamic acid solutions.

### Example of Synthesis 1

BAPP (57.3 g: 0.140 mol) and ODA (18.6 g, 0.093 mol) were dissolved in DMF (1173.5 g) cooled to 10° C. To the resulting solution, BPDA (27.4 g: 0.093 mol) and PMDA (25.4 g: 0.116 mol) were added. The resulting mixture was evenly stirred for 30 minutes to form a prepolymer.

After PDA (25.2 g: 0.232 mol) had been dissolved in this solution, PMDA (46.4 g: 0.213 mol) was dissolved. To the resulting solution, 115.1 g of a 7.2 wt % DMF solution of PMDA (PMDA: 0.038 mol) separately prepared were carefully added. The addition was stopped at a viscosity of approximately 2500 poise. The resulting mixture was stirred for 1 hour. Thus obtained was a polyamic acid solution having a rotational viscosity of 2600 poise at 23° C.

To 100 g of the resulting polyamic acid solution, 50 g of a curing agent composed of acetic anhydride/isoquinoline/DMF (with a weight ratio of 25.6 g/7.3 g/67.1 g) were added. The resulting mixture was stirred and defoamed at a temperature of 0° C. or lower to form a nonthermoplastic polyamic acid solution. The number of moles of each of the monomers used is shown in Table 1.

### Example of Synthesis 2

BAPP (57.3 g: 0.140 mol) and ODA (18.6 g, 0.093 mol) were dissolved in DMF (1173.5 g) cooled to 10° C. To the resulting solution, BTDA (30.0 g: 0.093 mol) and PMDA (25.4 g: 0.116 mol) were added. The resulting mixture was evenly stirred for 30 minutes to form a prepolymer.

After PDA (25.2 g: 0.232 mol) had been dissolved in this solution, PMDA (46.4 g: 0.213 mol) was dissolved. To the resulting solution, 115.1 g of a 7.2 wt % DMF solution of PMDA (PMDA: 0.038 mol) separately prepared were carefully added. The addition was stopped at a viscosity of approximately 2500 poise. The resulting mixture was stirred for 1 hour. Thus obtained was a polyamic acid solution having a rotational viscosity of 2600 poise at 23° C.

To 100 g of the resulting polyamic acid solution, 50 g of a curing agent composed of acetic anhydride/isoquinoline/DMF (with a weight ratio of 25.6 g/7.3 g/67.1 g) were added. The resulting mixture was stirred and defoamed at a temperature of 0° C. or lower to form a nonthermoplastic polyamic acid solution. The number of moles of each of the monomers used is shown in Table 1.

### Example of Synthesis 3

BAPP (118.6 g: 0.289 mol) was dissolved in 843.4 g of N,N-dimethylformamide (DMF). BPDA (67.7 g: 0.230 mol) was put into the resulting solution, and the resulting mixture was heated to 50° C. and then cooled to 10° C. BTDA (14.5 g: 0.045 mol) was added to the resulting mixture, whereby a prepolymer was obtained.

To the resulting solution, 55.2 g of a 7 wt % DMF solution of BTDA (BTDA: 0.012 mol) separately prepared were carefully added. Thus obtained was a polyamic acid solution having a solid-content concentration of approximately 17% by weight and a rotational viscosity of 800 poise at 23° C. Thereafter, a polyamic acid solution having a solid-content concentration of 14% by weight was obtained by adding DMF. The number of moles of each of the monomers used is shown in Table 1.

### Example of Synthesis 4

BAPP (118.6 g: 0.289 mol) was dissolved in 843.4 g of N,N-dimethylformamide (DMF). BPDA (50.6 g: 0.172 mol) was put into the resulting solution, and the resulting mixture was heated to 50° C. and then cooled to 10° C. BTDA (32.2 g: 0.100 mol) was added to the resulting mixture, whereby a prepolymer was obtained.

To the resulting solution, 69.0 g of a 7 wt % DMF solution of BTDA (BTDA: 0.015 mol) separately prepared were carefully added. Thus obtained was a polyamic acid solution having a solid-content concentration of approximately 17% by weight and a rotational viscosity of 800 poise at 23° C. Thereafter, a polyamic acid solution having a solid-content concentration of 14% by weight was obtained by adding DMF. The number of moles of each of the monomers used is shown in Table 1.

### Example of Synthesis 5

A polyamic acid solution having a solid-content concentration of approximately 17% by weight and a rotational viscosity of 800 poise at 23° C. was obtained by adding BPDA (85.6 g: 0.291 mol) first and then BAPP (118.6 g: 0.289 mol) to 937.6 g of N,N-dimethylformamide (DMF). Thereafter, a polyamic acid solution having a solid-content concentration of 14% by weight was obtained by adding DMF. The number of moles of each of the monomers used is shown in Table 1.

### Example of Synthesis 6

BAPP (118.6 g: 0.289 mol) was dissolved in 843.4 g of N,N-dimethylformamide (DMF). BPDA (12.7 g: 0.043 mol) was put into the resulting solution, and the resulting mixture was heated to 50° C. and then cooled to 10° C. PMDA (48.6 g: 0.223 mol) was added to the resulting mixture, whereby a prepolymer was obtained.

To the resulting solution, 65.4 g of a 7 wt % DMF solution of PMDA (PMDA: 0.021 mol) separately prepared were carefully added. Thus obtained was a polyamic acid solution having a solid-content concentration of approximately 17% by weight and a rotational viscosity of 800 poise at 23° C. Thereafter, a polyamic acid solution having a solid-content concentration of 14% by weight was obtained by adding DMF. The number of moles of each of the monomers used is shown in Table 1.

### Example of Synthesis 7

BAPP (118.6 g: 0.289 mol) was dissolved in 843.4 g of N,N-dimethylformamide (DMF). BPDA (21.5 g: 0.073 mol) was put into the resulting solution, and the resulting mixture was heated to 50° C. and then cooled to 10° C. PMDA (42.1 g: 0.193 mol) was added to the resulting mixture, whereby a prepolymer was obtained.

To the resulting solution, 65.4 g of a 7 wt % DMF solution of PMDA (PMDA: 0.021 mol) separately prepared were carefully added. Thus obtained was a polyamic acid solution having a rotational viscosity of 800 poise at 23° C. Thereafter, a polyamic acid solution having a solid-content concentration of 14% by weight was obtained by adding DMF. The number of moles of each of the monomers used is shown in Table 1.

### Example of Synthesis 8

BAPP (118.6 g: 0.289 mol) was dissolved in 843.4 g of N,N-dimethylformamide (DMF). BPDA (25.6 g: 0.087 mol) was put into the resulting solution, and the resulting mixture was heated to 50° C. and then cooled to 10° C. PMDA (39.0 g: 0.179 mol) was added to the resulting mixture, whereby a prepolymer was obtained.

To the resulting solution, 65.4 g of a 7 wt % DMF solution of PMDA (PMDA: 0.021 mol) separately prepared were carefully added. Thus obtained was a polyamic acid solution having a rotational viscosity of 800 poise at 23° C. Thereafter, a polyamic acid solution having a solid-content concentration of 14% by weight was obtained by adding DMF. The number of moles of each of the monomers used is shown in Table 1.

### Example of Synthesis 9

BAPP (118.6 g: 0.289 mol) was dissolved in 843.4 g of N,N-dimethylformamide (DMF). BPDA (42.4 g: 0.144 mol) was put into the resulting solution, and the resulting mixture was heated to 50° C. and then cooled to 10° C. PMDA (26.6 g: 0.122 mol) was added to the resulting mixture, whereby a prepolymer was obtained.

To the resulting solution, 65.4 g of a 7 wt % DMF solution of PMDA (PMDA: 0.021 mol) separately prepared were carefully added. Thus obtained was a polyamic acid solution having a rotational viscosity of 800 poise at 23° C. Thereafter, a polyamic acid solution having a solid-content concentration of 14% by weight was obtained by adding DMF. The number of moles of each of the monomers used is shown in Table 1.

### Example of Synthesis 10

BAPP (118.6 g: 0.289 mol) was dissolved in 843.4 g of N,N-dimethylformamide (DMF). BPDA (4.1 g: 0.014 mol) was put into the resulting solution, and the resulting mixture was heated to 50° C. and then cooled to 10° C. PMDA (55.0 g: 0.252 mol) was added to the resulting mixture, whereby a prepolymer was obtained.

To the resulting solution, 65.4 g of a 7 wt % DMF solution of PMDA (PMDA: 0.021 mol) separately prepared were carefully added. Thus obtained was a polyamic acid solution having a rotational viscosity of 800 poise at 23° C. Thereafter, a polyamic acid solution having a solid-content concentration of 14% by weight was obtained by adding DMF. The number of moles of each of the monomers used is shown in Table 1.

### Example of Synthesis 11

BAPP (118.6 g: 0.289 mol) was dissolved in 843.4 g of N,N-dimethylformamide (DMF). The resulting solution was cooled to 10° C., and PMDA (58.0 g: 0.266 mol) was added, whereby a prepolymer was obtained.

To the resulting solution, 65.4 g of a 7 wt % DMF solution of PMDA (PMDA: 0.021 mol) separately prepared were carefully added. Thus obtained was a polyamic acid solution having a rotational viscosity of 800 poise at 23° C. Thereafter, a polyamic acid solution having a solid-content concentration of 14% by weight was obtained by adding DMF. The number of moles of each of the monomers used is shown in Table 1.

### Example 1

By using a multi-manifold-type three-layer coextrusion multilayer die having a lip width of 200 mm, a three-layer structure composed of the polyamic acid solution of Example of Synthesis 3, the polyamic acid solution of Example of Synthesis 1, and the polyamic acid solution of Example of Synthesis 3 stacked in this order was extruded and flow-cast onto a sheet of aluminum foil. Next, after the resulting multilayer film was heated at 150° C. for 100 seconds, a gel film having a self-supporting property was removed, fixed into a metal frame, and dried and imidized at 250° C. for 40 seconds, 300° C. for 60 seconds, 350° C. for 60 seconds, and 370° C. for 30 seconds. Thus obtained was a multilayer polyimide film whose thermoplastic polyimide layer, nonthermoplastic polyimide layer, and thermoplastic polyimide layer have thicknesses of 4 μm, 17 μm, and 4 μm, respectively. A result of observation of the appearance of the resulting multilayer polyimide film is shown in Table 2. The symbol (A) indicates a case where neither whitening nor peeling was found as a result of observation of appearance (denoted as “No problems” in Table 2). The symbol (B) indicates a case where haze, but not whitening, was found as a result of observation of appearance (denoted as “Haze found” in Table 2). The symbol (C) indicates a case where both whitening and peeling were found as a result of observation of appearance (denoted as “Whitening and peeling” in Table 2).

After the fabrication of a metal-clad laminate with use of the multilayer polyimide film, the metal foil peel-strength was measured and the soldering heat resistance was evaluated. The results are tabulated in Table 2.

### Example 2

Example 2 was carried out in the same manner as Example 1, except for a three-layer structure composed of the polyamic acid solution of Example of Synthesis 4, the polyamic acid solution of Example of Synthesis 1, and the polyamic acid solution of Example of Synthesis 4 stacked in this order. The results are tabulated in Table 2.

### Example 3

Example 3 was carried out in the same manner as Example 1, except for a three-layer structure composed of the polyamic acid solution of Example of Synthesis 5, the polyamic acid solution of Example of Synthesis 1, and the polyamic acid solution of Example of Synthesis 5 stacked in this order. The results are tabulated in Table 2.

### Example 4

Example 4 was carried out in the same manner as Example 1, except for a three-layer structure composed of the polyamic acid solution of Example of Synthesis 3, the polyamic acid solution of Example of Synthesis 2, and the polyamic acid solution of Example of Synthesis 3 stacked in this order. The results are tabulated in Table 2.

### Example 5

Example 5 was carried out in the same manner as Example 1, except for a three-layer structure composed of the polyamic acid solution of Example of Synthesis 4, the polyamic acid solution of Example of Synthesis 2, and the polyamic acid solution of Example of Synthesis 4 stacked in this order. The results are tabulated in Table 2.

### Example 6

Example 6 was carried out in the same manner as Example 1, except for a three-layer structure composed of the polyamic acid solution of Example of Synthesis 6, the polyamic acid solution of Example of Synthesis 2, and the polyamic acid solution of Example of Synthesis 6 stacked in this order. The results are tabulated in Table 2.

### Example 7

Example 7 was carried out in the same manner as Example 1, except for a three-layer structure composed of the polyamic acid solution of Example of Synthesis 7, the polyamic acid solution of Example of Synthesis 2, and the polyamic acid solution of Example of Synthesis 7 stacked in this order. The results are tabulated in Table 2.

### Example 8

Example 8 was carried out in the same manner as Example 1, except for a three-layer structure composed of the polyamic acid solution of Example of Synthesis 8, the polyamic acid solution of Example of Synthesis 2, and the polyamic acid solution of Example of Synthesis 8 stacked in this order. The results are tabulated in Table 2.

### Example 9

Example 9 was carried out in the same manner as Example 1, except for a three-layer structure composed of the polyamic acid solution of Example of Synthesis 9, the polyamic acid solution of Example of Synthesis 2, and the polyamic acid solution of Example of Synthesis 9 stacked in this order. The results are tabulated in Table 2.

### Example 10

Example 10 was carried out in the same manner as Example 1, except for a three-layer structure composed of the polyamic acid solution of Example of Synthesis 10, the polyamic acid solution of Example of Synthesis 2, and the polyamic acid solution of Example of Synthesis 10 stacked in this order. The results are tabulated in Table 2.

### Example 11

Example 11 was carried out in the same manner as Example 1, except for a three-layer structure composed of the polyamic acid solution of Example of Synthesis 11, the polyamic acid solution of Example of Synthesis 2, and the polyamic acid solution of Example of Synthesis 11 stacked in this order. The results are tabulated in Table 2.

### Comparative Example 1

Comparative Example 1 was carried out in the same manner as Example 1, except for a three-layer structure composed of the polyamic acid solution of Example of Synthesis 5, the polyamic acid solution of Example of Synthesis 2, and the polyamic acid solution of Example of Synthesis 5 stacked in this order. The results are tabulated in Table 2.

TABLE 1

| | Number of moles used | | | | | |
|---|---|---|---|---|---|---|
| | Ex. | Ex. | Ex. | Ex. | Ex. | Ex. |
| | Syn. 1 | Syn. 2 | Syn. 3 | Syn. 4 | Syn. 5 | Syn. 6 |
| BAPP | 0.140 | 0.140 | 0.289 | 0.289 | 0.289 | 0.289 |
| ODA | 0.093 | 0.093 | | | | |
| PDA | 0.232 | 0.232 | | | | |
| BPDA | 0.093 | | 0.230 | 0.172 | 0.291 | 0.043 |
| BTDA | | 0.093 | 0.057 | 0.115 | | |
| PMDA | 0.367 | 0.367 | | | | 0.244 |

| | Number of moles used | | | | |
|---|---|---|---|---|---|
| | Ex. | Ex. | Ex. | Ex. | Ex. |
| | Syn. 7 | Syn. 8 | Syn. 9 | Syn. 10 | Syn. 11 |
| BAPP | 0.289 | 0.289 | 0.289 | 0.289 | 0.289 |
| ODA | | | | | |
| PDA | | | | | |
| BPDA | 0.073 | 0.087 | 0.144 | 0.014 | |
| BTDA | | | | | |
| PMDA | 0.214 | 0.200 | 0.143 | 0.273 | 0.287 |

TABLE 2

| | Ex. 1 | Ex. 2 | Ex. 3 | Ex. 4 | Ex. 5 | Ex. 6 |
|---|---|---|---|---|---|---|
| Non- | Ex. | Ex. | Ex. | Ex. | Ex. | Ex. |
| thermoplastic | Syn. 1 | Syn. 1 | Syn. 1 | Syn. 2 | Syn. 2 | Syn. 2 |
| polyimide | | | | | | |
| Thermoplastic | Ex. | Ex. | Ex. | Ex. | Ex. | Ex. |
| polyimide | Syn. 3 | Syn. 4 | Syn. 5 | Syn. 3 | Syn. 4 | Syn. 6 |
| Proportion | 90 | 80 | 100 | 60 | 70 | 93 |
| of acid | | | | | | |
| dianhydride | | | | | | |
| and diamine | | | | | | |
| contained in | | | | | | |
| thermoplastic | | | | | | |
| polyimide and | | | | | | |
| used in non- | | | | | | |
| thermoplastic | | | | | | |
| polyimide | | | | | | |
| Metal foil | 15 | 15 | 15 | 12 | 13 | 15 |
| peel-strength | | | | | | |
| (N/cm) | | | | | | |
| Appearance | A | A | A | B | B | A |
| Soldering heat | 310 | 310 | 300 | 310 | 310 | 350 |
| resistance | | | | | | |
| (Normal) | | | | | | |
| (° C.) | | | | | | |
| Soldering heat | 260 | 260 | 250 | 260 | 260 | 300 |
| resistance | | | | | | |
| (Hygroscopic) | | | | | | |
| (° C.) | | | | | | |
| | Comp. | | | | | |
| | Ex. 1 | Ex. 7 | Ex. 8 | Ex. 9 | Ex. 10 | Ex. 11 |
| Non- | Ex. | Ex. | Ex. | Ex. | Ex. | Ex. |
| thermoplastic | Syn. 2 | Syn. 2 | Syn. 2 | Syn. 2 | Syn. 2 | Syn. 2 |
| polyimide | | | | | | |
| Thermoplastic | Ex. | Ex. | Ex. | Ex. | Ex. | Ex. |
| polyimide | Syn. 5 | Syn. 7 | Syn. 8 | Syn. 9 | Syn. 10 | Syn. 11 |
| Proportion | 50 | 87 | 85 | 75 | 98 | 100 |
| of acid | | | | | | |
| dianhydride | | | | | | |
| and diamine | | | | | | |
| contained in | | | | | | |
| thermoplastic | | | | | | |
| polyimide and | | | | | | |
| used in non- | | | | | | |
| thermoplastic | | | | | | |
| polyimide | | | | | | |
| Metal foil | 10 | 15 | 15 | 15 | 10 | 8 |
| peel-strength | | | | | | |
| (N/cm) | | | | | | |
| Appearance | C | A | A | A | A | A |
| Soldering heat | 300 | 330 | 320 | 300 | 350 | 350 |
| resistance | | | | | | |
| (Normal) | | | | | | |
| (° C.) | | | | | | |
| Soldering heat | 250 | 290 | 280 | 260 | 310 | 310 |
| resistance | | | | | | |
| (Hygroscopic) | | | | | | |
| (° C.) | | | | | | |

(Note)
Appearance A: No problems; B: Haze found; C: Whitening and peeling

### INDUSTRIAL APPLICABILITY

The present invention makes it possible to provide a multilayer polyimide film that hardly suffers from the peeling of the layers from each other or the clouding of a space between the layers (turning white in color) during heating at a high temperature and a flexible metal-clad laminate using such a multilayer polyimide film. Therefore, the present invention can be widely applied in an industrial field where flexible metal-clad laminates are produced or used.

1. A multilayer polyimide film having a thermoplastic polyimide layer on at least one side of a nonthermoplastic polyimide layer, wherein at least 60% of the total number of moles of an acid dianhydride monomer and a diamine monomer that constitute the thermoplastic polyimide is the same type of monomer as at least one type of acid dianhydride monomer and at least one type of diamine monomer that constitute the nonthermoplastic polyimide.

2. The multilayer polyimide film as set forth in claim 1, wherein at least 80% of the total number of moles of the acid dianhydride monomer and the diamine monomer that constitute the thermoplastic polyimide is the same type of monomer as said at least one type of acid dianhydride monomer and said at least one type of diamine monomer that constitute the nonthermoplastic polyimide.

3. The multilayer polyimide film as set forth in claim 1, wherein the acid dianhydride monomer that constitutes the thermoplastic polyimide is at least one type of acid dianhydride selected from the group consisting of pyromellitic acid dianhydride, 3,3′,4,4′-biphenyltetracarboxylic acid dianhydride, and 3,3′,4,4′-benzophenonetetracarboxylic acid dianhydride.

4. The multilayer polyimide film as set forth in claim 1, wherein the diamine monomer that constitutes the thermoplastic polyimide is 4,4′-diaminodiphenylether or 2,2-bis[4-(4-aminophenoxy)phenyl]propane.

5. The multilayer polyimide film as set forth in claim 1, wherein the acid dianhydride monomer that constitutes the thermoplastic polyimide is a combination of pyromellitic acid dianhydride and 3,3′,4,4′-biphenyltetracarboxylic acid dianhydride, and the diamine monomer that constitutes the thermoplastic polyimide is 2,2-bis[4-(4-aminophenoxy)phenyl]propane.

6. The multilayer polyimide film as set forth in claim 5, wherein the ratio between pyromellitic acid dianhydride and 3,3′,4,4′-biphenyltetracarboxylic acid dianhydride, which are acid dianhydride monomers that constitute the thermoplastic polyimide, is 70/30 to 95/5.

7. The multilayer polyimide film as set forth in claim 1, wherein the acid dianhydride monomer that constitutes the thermoplastic polyimide is pyromellitic acid dianhydride, and the diamine monomer that constitutes the thermoplastic polyimide is 2,2-bis[4-(4-aminophenoxy)phenyl]propane.

8. The multilayer polyimide film as set forth in claim 1, said multilayer polyimide film being produced by multilayer coextrusion.

9. A flexible metal-clad laminate obtained by bonding a sheet of metal foil to a multilayer polyimide film as set forth in claim 1.

10. The multilayer polyimide film as set forth in claim 5, said multilayer polyimide film being produced by multilayer coextrusion.

11. The multilayer polyimide film as set forth in claim 6, said multilayer polyimide film being produced by multilayer coextrusion.

12. The multilayer polyimide film as set forth in claim 7, said multilayer polyimide film being produced by multilayer coextrusion.

13. A flexible metal-clad laminate obtained by bonding a sheet of metal foil to a multilayer polyimide film as set forth in claim 5.

14. A flexible metal-clad laminate obtained by bonding a sheet of metal foil to a multilayer polyimide film as set forth in claim 6.

15. A flexible metal-clad laminate obtained by bonding a sheet of metal foil to a multilayer polyimide film as set forth in claim 7.

16. A flexible metal-clad laminate obtained by bonding a sheet of metal foil to a multilayer polyimide film as set forth in claim 10.

17. A flexible metal-clad laminate obtained by bonding a sheet of metal foil to a multilayer polyimide film as set forth in claim 11.

18. A flexible metal-clad laminate obtained by bonding a sheet of metal foil to a multilayer polyimide film as set forth in claim 12.
